(19) United States
(12) Patent Application Publication
(10) Pub. No.: US 2012/0271695 A1
(43) Pub. Date: Oct. 25, 2012

(54) Management Device for Point Circulation Between Constituent Members, System and Method for Point Circulation Between Constituent Members

(75) Inventor: Hikaru Deguchi, Shibuya-ku (JP)

(73) Assignees: MEKIKI CREATES CO., LTD., Shibuya-ku, Tokyo (JP); MEKIKI CO., LTD., Shibuya-ku, Tokyo (JP)

(21) Appl. No.: 13/395,409

(22) PCT Filed: Sep. 13, 2010
(86) PCT No.: PCT/JP2010/065699

§ 371 Date: May 24, 2012

(30) Foreign Application Priority Data
Sep. 11, 2009 (JP) 2009-210533

(51) Int. Cl. G06Q 30/02

(52) U.S. Cl. 705/14.23

(57) ABSTRACT

To grant a point according to an action contributed to a community to make it possible to receive discount by the point when trading a product between members of the community.

A device for managing member-to-member distribution point 1 receives shop opening information containing a Web page from a member terminal 2a to provide a sales site. On the other hand, upon receiving posting of a diary and the like from a member terminal 2b, the device 1 grants a point value according to the action of the member to record point balance for each member into a database. When a member purchases a product at a sales site, the member can receive discount according to the degree of human relationship among the members. The device for managing member-to-member distribution point 1 subtracts a point value corresponding to the discount amount from the point balance in the database.

### FIELD OF THE INVENTION

The present invention relates to a system that grants a point to an action contributed to a community and utilizes the point for trading a product among members of the community. The present invention also relates to a device and a method of managing the point used in the system.

### BACKGROUND OF THE INVENTION

A point system, which expects customers revisit and retention, is actively introduced by various commercial entities that grant a point to customers to make it possible to be used in exchange of discounts and gift products.

This point system is configured so that the more products are purchased, the more points are granted, thus providing great benefits for wealthier people. Those who purchase a great amount of products can be said to contribute to the society from a viewpoint of boosting personal consumption. However, there are many people who contribute for the society without involvement in money in the world. A current point system is limited to a giving and receiving relation of money. For this reason, there is no idea to reward those who work hard for the society.

In view of this problem, an “electronic payment method and system for supporting sales promotion” according to PTL 1 makes a clear departure from a conventional point system in which only a purchaser gains an advantage, in that points are granted by submitting open information such as a diary to a social networking service (hereinafter referred to as “SNS”) site.

### CITATION LIST

### Patent Literature

PTL 1: JP2009-169977A

### SUMMARY OF THE INVENTION

### Problems to be Solved by the Invention

In the invention disclosed by PTL 1, a seller manages an SNS as a part of sales promotion and the seller who is, at the same time, an administrator of the site bears the point. In other words, the seller can be said to use the SNS, which is a medium for collecting customers. In such a case, the seller and purchaser are both participants. Accordingly, no idea is found that a participant contributes something for all and the participant receives a monetary reward from other participant when purchasing a product. A kind of mutual assistance in which associates contribute to one another is quite a different idea from a structure in which only an administrator bears a burden one-sidedly as advertising expense like the system in PTL 1.

In an on-line shopping area where a plurality of shops participate, the point system is widely used. When a participant shop tries to issue a point separately, it is necessary to manage which store has issued how many points to which user. If 100 shops were opened, the 100 shops would have to prepare database for managing user points separately. This is a heavy burden. Whatever may be the case of a full-time shop, an individual who exhibits avocational home-prepared goods cannot provide a unique point with a customer as a service.

When a supermarket did not exist, a shop of face-to-face selling used to be a mainstream of retailing. It is a greengrocer's, a fish store, a meat shop, and the like in the neighborhood run by a family. Since a child always comes on an errand, the child deserves one more orange as bonus. An elderly woman who lives in the neighborhood deserves a discount of a fraction of five yen. Those situations used to be common practice. The present invention proposes addition of element that cannot be measured by money to a community linked by the Internet. The object of the invention is, for example, to achieve in the world of the Internet such that since a seller has received a lot of assistance from a friend, the seller will give the friend a discount.

It also is a trial to find a “knowledgeable grandpa” and a “good grandma”, who used to be always in the town in the world, in the world of the Internet to reward them therein.

Another object is to make it possible for even a small-scale shop such as a private shop and second job who attempts to sell products to others by integrally managing database to provide a customer with a point service.

### Means to Solve the Problems

In order to achieve the above-mentioned object, the invention according to claim 1 is a device for managing a point that is communicably connected with a group of member terminals, the group of member terminals being composed of terminals of community members to manage a point circulating among community members, and includes:

shop opening information storage means for storing information containing shop opening Web page data related to a member who opens a shop; and

point value storage means by action for making each predetermined action (hereinafter referred to as a “specified action”) correspond with a point value.

The device for managing member-to-member distribution point also includes:

point granting means for granting a point value to a member who has adopted the specified action to record a point balance into member information storage means for each member;

discount information display means for making the shop opening Web page display a point balance and discount information of the member when the member terminal of the member intended to purchase a product accesses the shop opening Web page; and

point balance update means for subtracting a point value used for purchasing a product from the point balance.

The discount information is stored in the discount information storage means of the device for managing member-to-member distribution point, received from the member terminal of the member who has opened the shop to be registered into the discount information storage means, or described in the shop opening Web page data.

Here, a “community” is composed of a plurality of members having a common purpose and taste. A “member” can be a seller or a purchaser.

A “product” includes not only a tangible product but also a service, or an intangible product.

A “point” is a value exchangeable for a product in the same way as money, For example, when one point is set as one yen, a hundred points are worth a hundred yen.

“Discount information” is information for deciding the amount of money that can be reduced from the price of a product using a point. Discount information includes a discount rate, an amount of discount, and the like. A discount rate is a predetermined ratio of money that can be reduced with the points from the price to the price. The amount of discount is a predetermined amount of money that can be reduced from the price. In the following embodiments, the discount rate is mainly used for the discount information.

In this way, those who take action for a community save a point and can use it for discount when purchasing a product from a member group. A point service of the present invention has never disclosed before. Since a device for managing member-to-member distribution point manages a point value for each member, a seller of a product can be free from troublesomeness accompanied by point management.

The community may be an SNS. In that case, the device for managing member-to-member distribution point is managed by an administrator of the SNS. A member of the SNS becomes the member of the relevant system.

Accordingly, since the SNS adopting the system of the invention has a different feature from other SNSs, the number of new participants can be expected to increase.

The specified action to be object for granting points includes posting of a blog, posting of a comment to a blog, posting of a diary, posting of a comment to the diary of other members, posting of a product review, reply to the consultation from other members, start-up of a lower community, invitation of a new participant to the community, and the like.

Sometimes a community may include a lower community and can take a hierarchical structure where the lower community includes a further lower community. A member of an upper community may participate in any number of lower communities.

The uppermost community should manage a point value, which is an important function of the invention. That is, the administrator of the uppermost community usually operates the device for managing member-to-member distribution point.

The device for managing member-to-member distribution point includes means for storing information on a member-to-member relationship. In the discount information, a value is set by the member-to-member relationship. The discount information display means may extract and display discount information corresponding to a relationship between a member who is an exhibitor and a member who is a purchaser.

The member-to-member relationship is, for example, friends, the friend of a friend, or the like.

This allows a seller to adjust the discount information according to the degree of intimacy with a purchaser instead of equalizing the discount rate to any member. The same things are performed on a shop on the Internet as local shops used to perform a business where a man who is an acquaintance deserves a discount, or a man without relationship deserves a fixed price.

The device for managing member-to-member distribution point includes means for storing an attribution in the community related to contribution to the community for each member. In the discount information, a value is set by the attribution in the community. The discount information display means may extract and display discount information corresponding to the attribution in the community of a member who is a purchaser.

When classifying a member by the attribution in the community, a blog poster, a diary poster, a consultation responder having expert knowledge, and those who invited others to the community are included. They are examples and may be appropriately set.

The discount information such as a discount rate can be adjusted by the degree of contribution to the community instead of making it equal. As a result, those who have contributed to the community can be rewarded even when the seller is not intimate with them.

The device for managing member-to-member distribution point may include settlement means that settles the price that the member who has purchased a product pays to the member who is the seller after discount using the point.

Thus, with the settlement means, subtraction of discount amount from point balance can be fixed after confirming reception of money. It is because when point balance is updated prior to confirming reception of money, inconsistency in point balance occurs when purchase of the product is cancelled.

The device for managing member-to-member distribution point is connected to an external database management device via a communication line.

At least point balance among data stored in the member information storage means is stored in the point balance external storage means provided in the database management device. The device for managing member-to-member distribution point may read and write data from the point balance external storage means via a communication line.

Accordingly, the device for managing member-to-member distribution point can manage point balance only by transmitting a database operation command to an external device without software to manage the point balance implemented thereon.

### ADVANTAGES

A seller of a product can circulate a point over the counter with a sensation that “one who is an acquaintance or contributes to the community deserves a discount.”

The system administrator collectively manages the database so that no individual setting is necessary. Consequently, regardless of the size of a scale, those that intend to sell a product to a member group can provide point service of the present invention with customers.

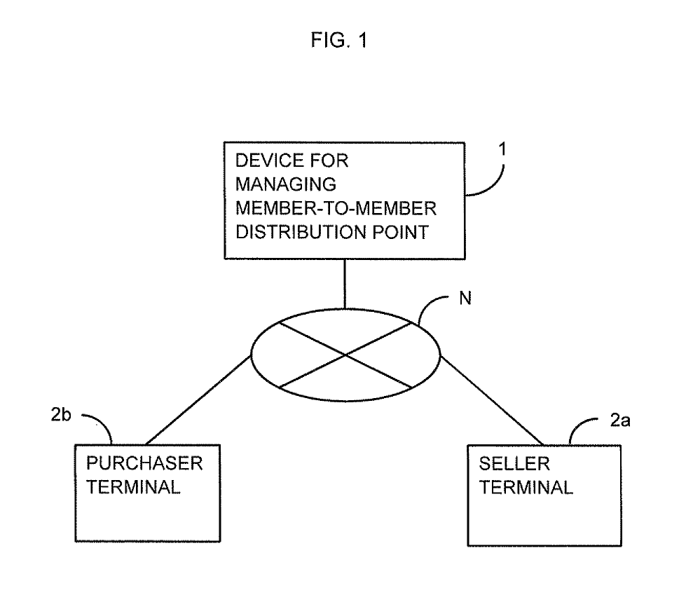

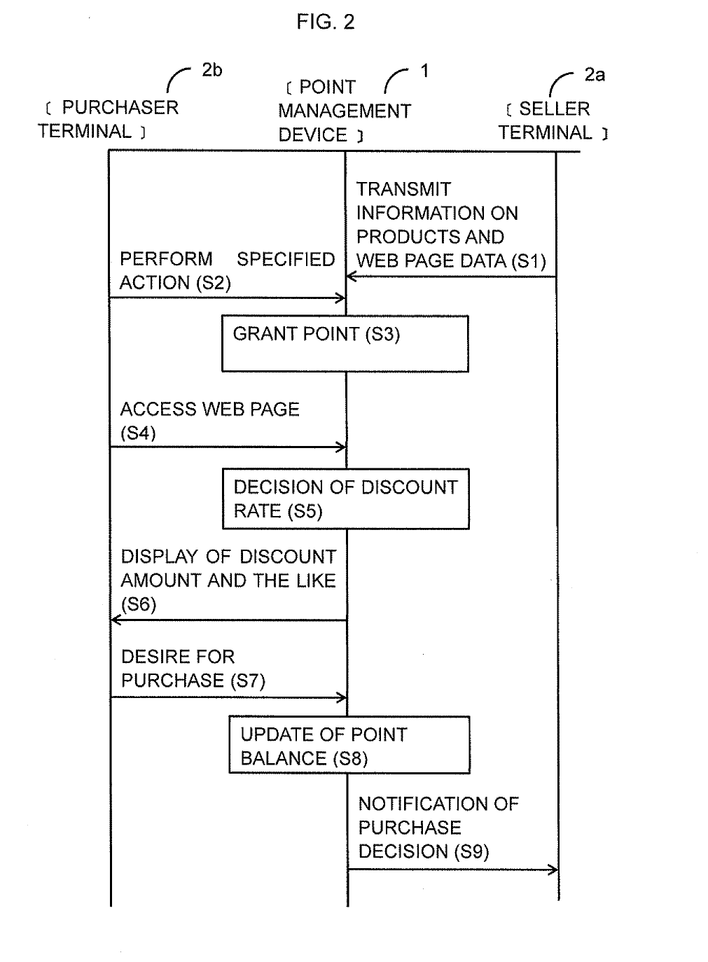

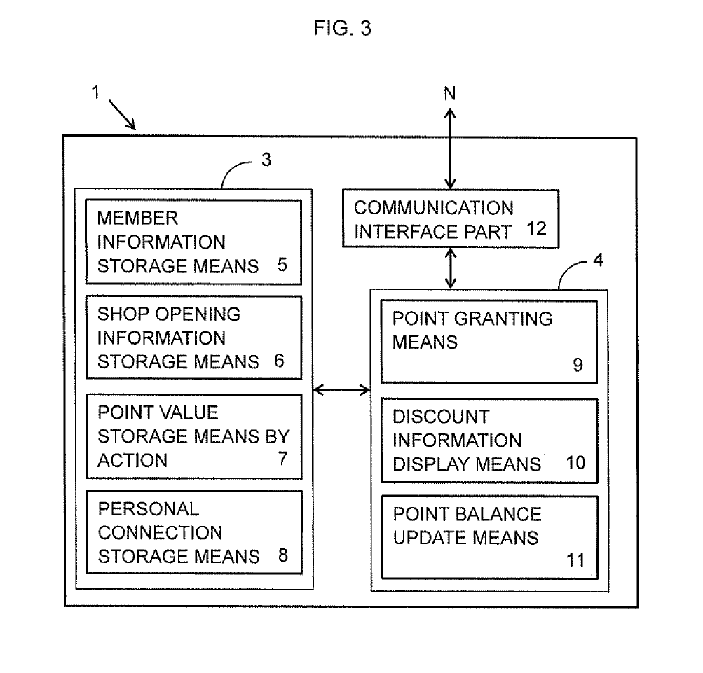

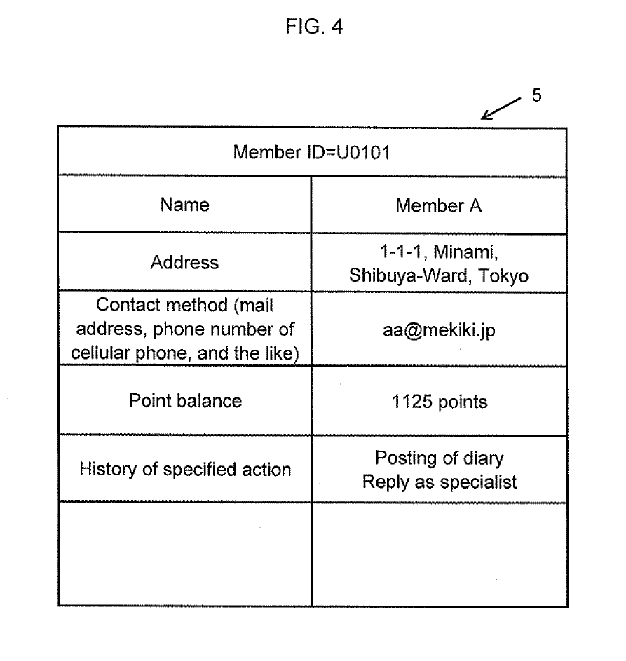

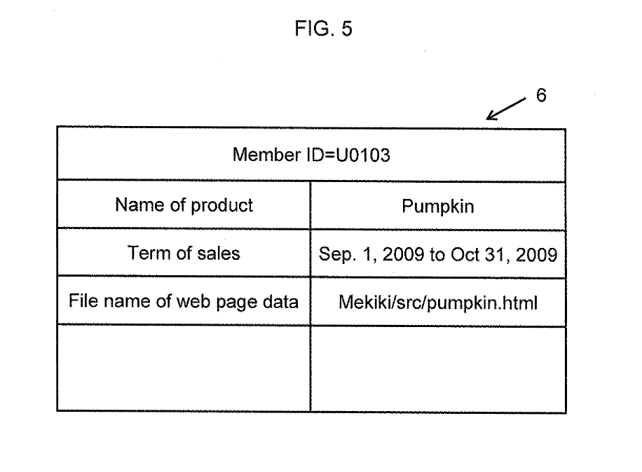

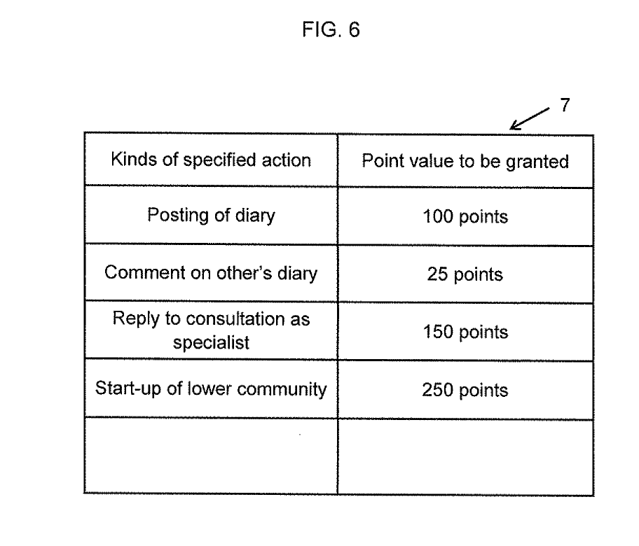

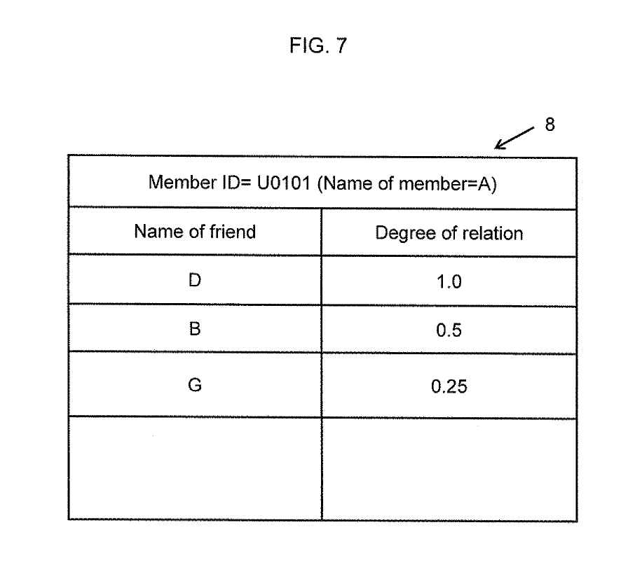

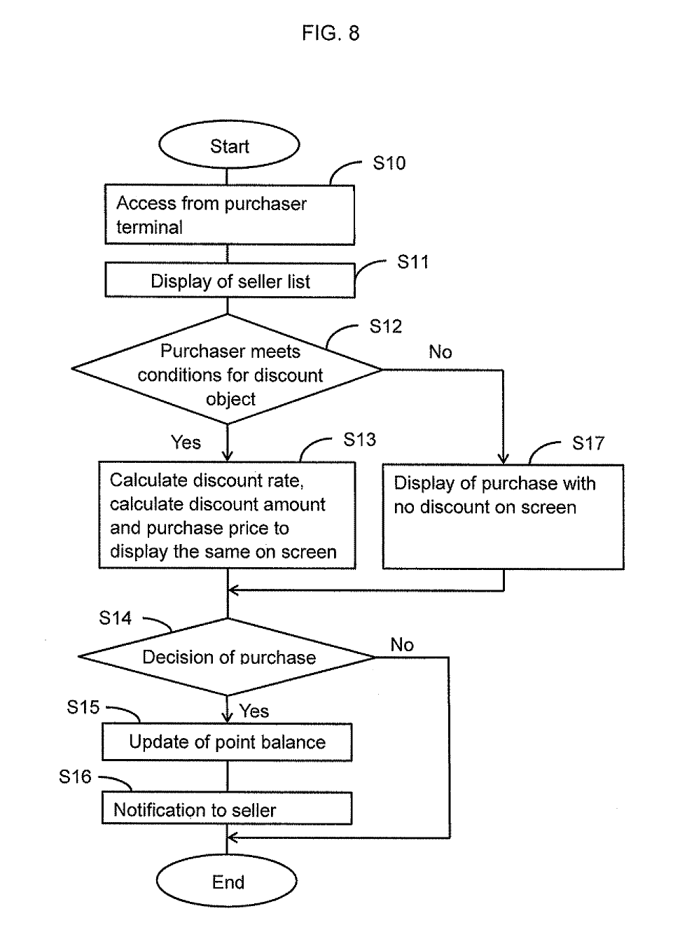

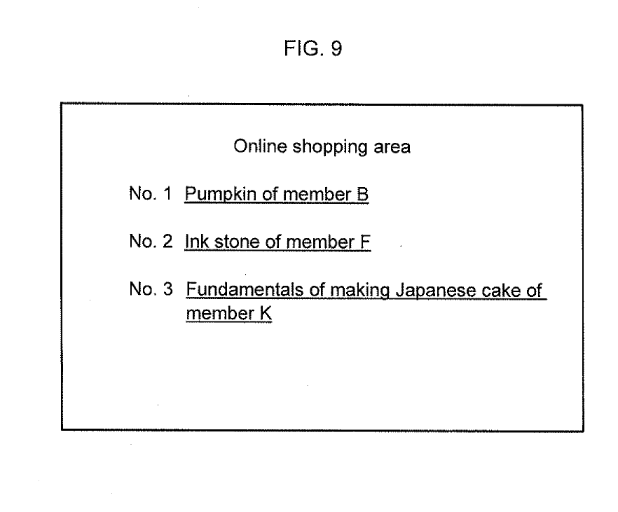

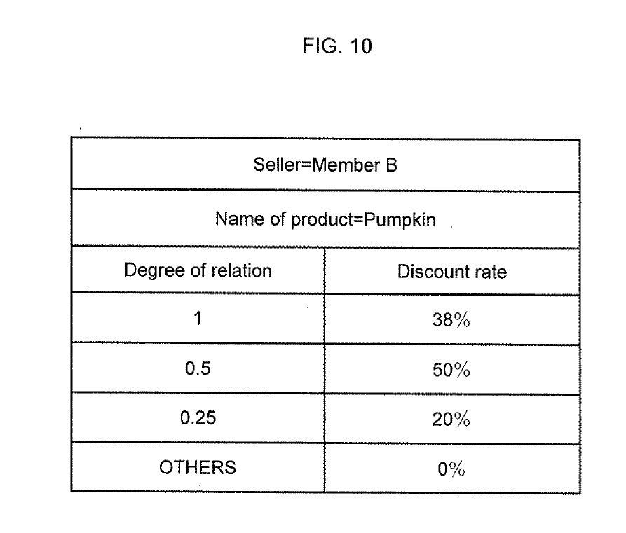

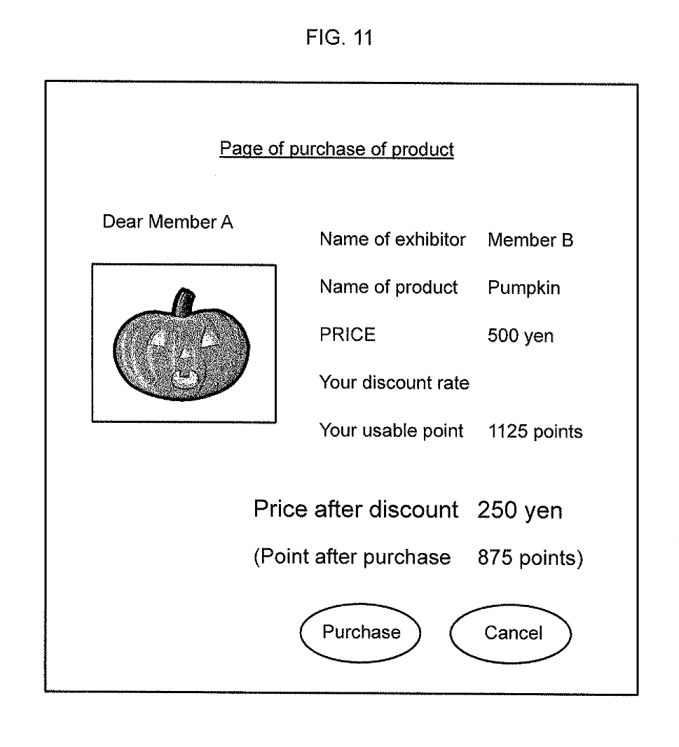

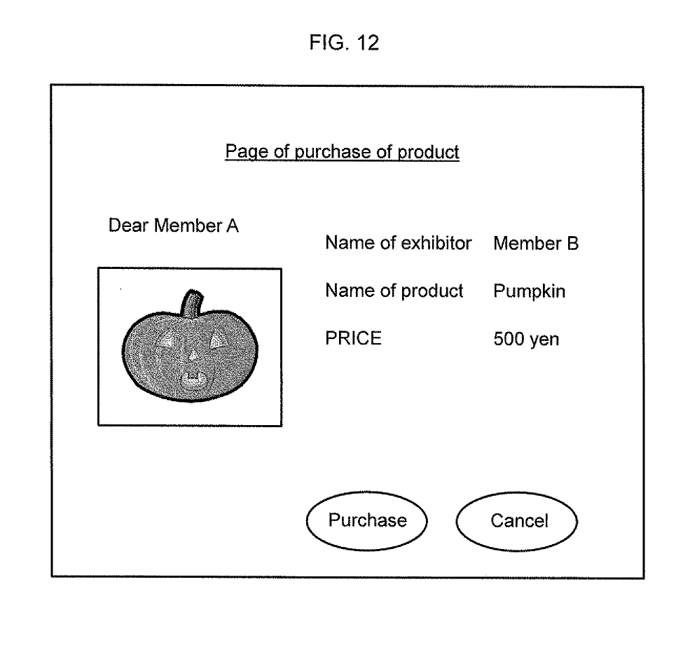

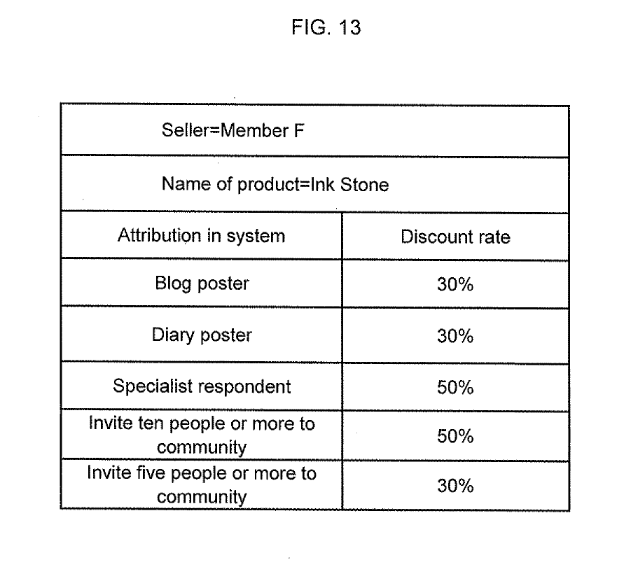

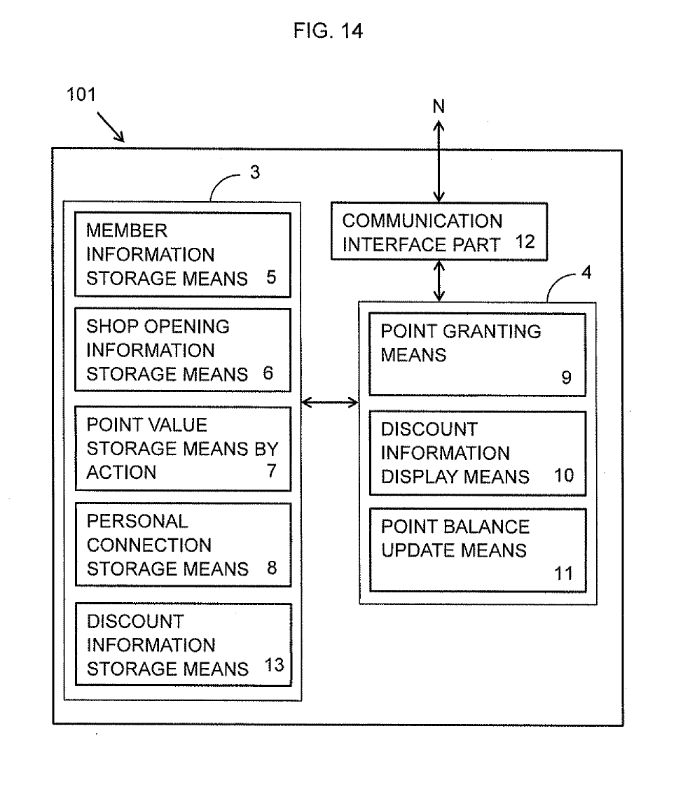

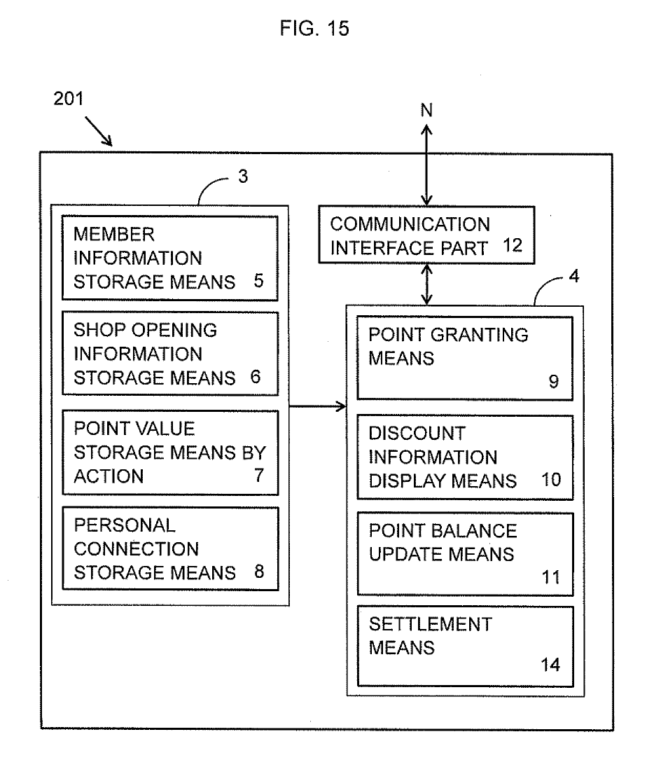

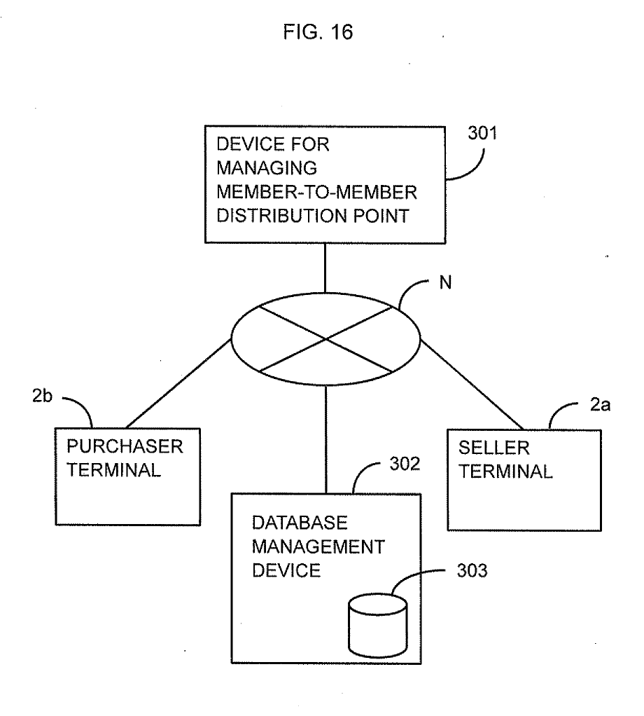

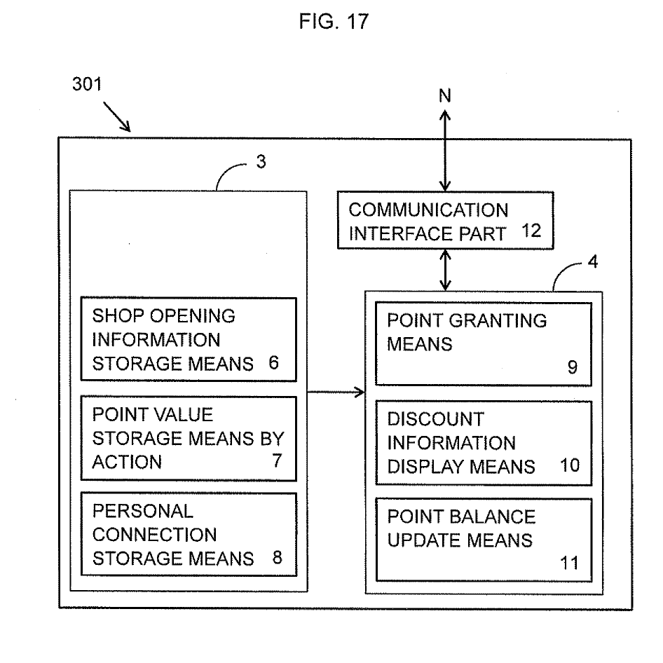

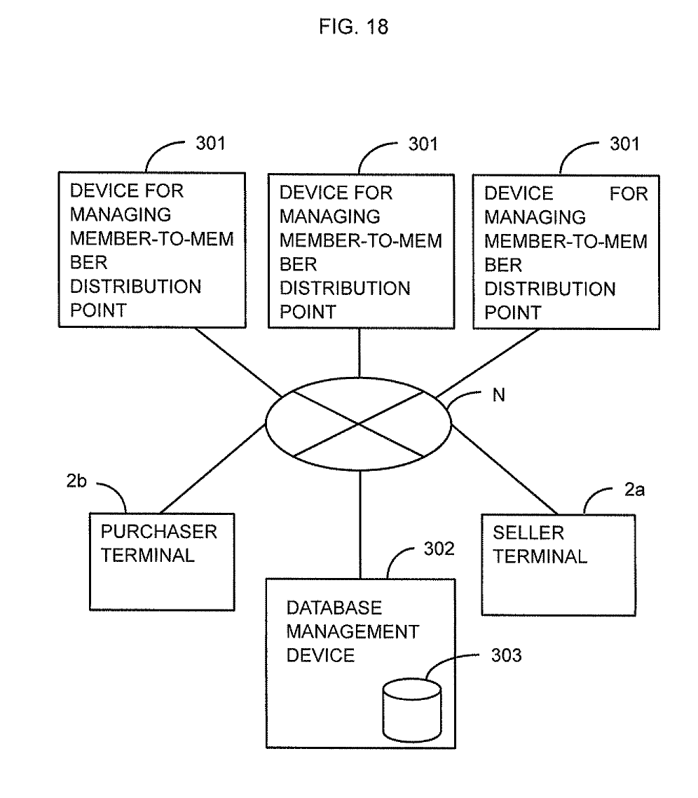

### BRIEF DESCRIPTION OF DRAWINGS

[FIG. 1] FIG. 1 is a system configuration diagram of Embodiment 1.

[FIG. 2] FIG. 2 is a sequence diagram illustrating outline of processing of the system of Embodiment 1.

[FIG. 3] FIG. 3 is a function block diagram of a device for managing member-to-member distribution point of Embodiment 1.

[FIG. 4] FIG. 4 is a diagram illustrating a data structure stored in the member-to-member information storage means of Embodiment 1.

[FIG. 5] FIG. 5 is a diagram illustrating a data structure stored in shop opening information storage means of Embodiment 1.

[FIG. 6] FIG. 6 is a diagram illustrating a data structure stored in point value storage means by action of Embodiment 1.

[FIG. 7] FIG. 7 is a diagram illustrating a data structure stored in personal connection storage means of Embodiment 1.

[FIG. 8] FIG. 8 is a flowchart illustrating a procedure of purchase of Embodiment 1.

[FIG. 9] FIG. 9 is an exemplary display screen of an on-line shopping area of Embodiment 1.

[FIG. 10] FIG. 10 is an exemplary diagram correspondence between member-to-member relationships and discount rates in Embodiment 1.

[FIG. 11] FIG. 11 is an exemplary display screen of product purchasing when a discount is available in Embodiment 1.

[FIG. 12] FIG. 12 is an exemplary display screen of product purchasing when no discount is available in Embodiment 1.

[FIG. 13] FIG. 13 is an exemplary diagram correspondence between attributes in the community and discount rates in Embodiment 2.

[FIG. 14] FIG. 14 is a function block diagram of the device for managing member-to-member distribution point of Embodiment 3.

[FIG. 15] FIG. 15 is a function block diagram of the device for managing member-to-member distribution point of Embodiment 5.

[FIG. 16] FIG. 16 is a system configuration diagram of Embodiment 6.

[FIG. 17] FIG. 17 is a function block diagram of the device for managing member-to-member distribution point of Embodiment 6.

[FIG. 18] FIG. 18 is a system configuration diagram of a variation example of Embodiment 6.

### BEST MODES FOR CARRYING OUT THE INVENTION

### Embodiment 1

FIG. 1 shows an exemplary system configuration of Embodiment 1.

A device for managing member-to-member distribution point 1 (hereinafter, referred to as a “point management device 1”) and a member terminal 2 are connected via the Internet N. In the following description, a member terminal is referred to as a seller terminal 2a when the member is a seller. When the member is a purchaser, the member terminal is referred to as a purchaser terminal 2b. Since the same member may be a seller or a purchaser at the time of trading products, the member terminal of the same member may be the seller terminal or purchaser terminal. In the case of no need for discriminating the member terminal between the seller terminal 2a and purchaser terminal 2b, it may be sometimes described as the “member terminal 2.”

Since the point management device 1 is usually operated by an administrator of the community, a management computer of the community may bear the function of the point management device I as a part of the management function. Alternatively, the point management device I may be an information processing device dedicated to the present system.

A point management device 1 does not necessarily have to execute its functions alone but a plurality of information processing devices may execute the function of operation management of the system in corporation.

Although there is no limit to the number of the member terminal 2, only two units (one is the seller terminal 2a, and the other is the purchaser terminal 2b) are described for simplifying descriptions in FIG. 1.

The member terminal 2 is an information processing device that the member uses and can communicate with the point management device 1. The member terminal 2 may be anything such as a cellular phone, a PC, and a PDA so long as a function for browsing the Web site (the Web browser) is provided. However, when used as the seller terminal 2a, since shop opening Web page data has to be prepared and updated, a PC is appropriate.

It goes without saying that the member terminal 2 has a user interface that receives instructions of the member, who is a user.

Before explaining Embodiment 1 in detail, outline of the system will be described according to FIG. 2 assuming the case of one purchaser and one seller.

A member who intends to sell a product in the community transmits information on the product and shop-opening Web page data from the seller terminal 2a to the point management device 1 (S1), The Web page data may be those that correspond to a shop, those for each product to be handled, or a combination thereof. The point management device 1 also serves as a Web server and stores Web page data transmitted by one or more seller terminals 2a. When accessed by the purchaser terminal 2b, the point management device 1 transmits the relevant Web page data to make the purchaser terminal 2b display it on the screen. That is, the point management device 1 forms an online shopping area.

The member posts a diary and comments on others' diary from the purchaser terminal 2b to the point management device 1 (S2).

The point management device 1 grants a point to the relevant member to store point balance (S3).

When a browsing request of a Web page of a seller is issued from a purchaser terminal 2b (S4), a discount rate is decided (S5), and point balance and Web page data showing discount information inherent to the purchase applicant are transmitted to the purchaser terminal 2b (S6). Upon decision of purchase by the purchaser (S7), the point management device 1 updates the point balance in the database subjected to centralized control (S8) to notify the seller terminal 2a of which member has decided purchase and what is the discount amount and trading price, and the like (S9).

In Embodiment 1, although providing point management and an installation place of an online shop for the seller, the point management device 1 does not involve in delivery of a purchased product, settlement of an amount of money after the discount, or the like. Since these are performed between the purchaser and seller by some means or other, or provided by the administrator of the system as a separate service, they are beyond the scope of Embodiment 1.

Respective processing of steps S1 and S2 is not necessarily performed in this order. As long as it is before S4, it may be performed at any timing for any number of repetitions.

Next, descriptions will be given to the configuration of the point management device 1 according to the block diagram of FIG. 3.

The point management device I includes a storage part 3 and a processing part 4. The storage part 3 includes member information storage means 5, shop opening information storage means 6, point value storage means by action 7, and personal connection storage means 8.

The processing part 4 includes point granting means 9, discount information display means 10, point balance update means 11, and other processing means.

However, classification of these means is just an example for ease of explanation. Respective means are implemented as hardware or software according to the function. In the case of software, a CPU executes a computer program stored in storage means such as a ROM and a hard disk. Since they are widely known, descriptions will be abbreviated.

Although no descriptions are given in FIG. 3, the storage part 3 includes storage means that stores interim data for work in the course of processing, parameters, Web data, and the like.

The point management device 1 includes I/O means such as a keyboard and a display and drivers, and a communication interface part 12 that makes it possible to communicate with the member terminal 2 and other information processing devices via a communication network.

In the member information storage means 5, the administrator of a community stores information on the member. It is mainly personal information such as a name, an address, and a mail address of the member. Point balance granted to each member is also stored. FIG. 4 shows an example of a data structure to be stored. As shown in FIG. 4, a history such that what kind of actions has been taken for the community may be recorded. The mail address and the number of a cellular phone may be used in place of an ID for identifying the member.

The shop opening information storage means 6 stores information on a product to be sold by a member. FIG. 5 shows an example of a data structure to be stored. The shop opening information storage means 6 stores the name of a product and a sales period as well as information for identifying the member such as a member ID. The name of an HTML file in which data of a shop opening Web page (exemplified in FIGS. 11 and 12) is also stored. The Web page data may be prepared by the point management device 1 based on information transmitted by the seller or prepared by the seller to be transmitted to the point management device 1. The point management device I may include a function to integrally manage the Web page data of the member intended to open a shop and prepare the Web page data as shown in FIG. 9 at the time of updating or displaying data to form an online shopping area in a processing part 4, or make other computers function as a Web server.

The point value storage means by action 7 stores a different point value according to each predetermined action (hereinafter referred to as “specified action”). FIG. 6 shows an example of a data structure to be stored.

In the example of FIG. 6, it is shown that 100 points will be granted when a diary is posted to be open information, and 25 points will be granted when comments on the diary of other members are described, for example. The data may be set at the time of starting system operation and may be changed during system operation as needed. A corresponding amount of money per point is specified in advance such that one point is one yen. In the following example, one point corresponds to one yen. For example, in order to accept a 30-yen discount from the price, 30 points are used.

The specified action via the member terminal 2 is received by the point management device 1 and a kind of the action is judged. Accordingly, the processing part 4 of the point management device 1 includes a function for receiving posted information such as a diary and a comment and the like. Since it is not essence of the invention, descriptions are abbreviated. In addition, it goes without saying that the processing part 4 includes a function for disclosing so that posted information can be browsed by the member.

The personal connection storage means 8 stores a friend of each member with a degree of relationship, that is, a degree of intimacy. FIG. 7 shows an example of a data structure to be stored. When a frequency (degree of relationship) of 1.0 is granted to a friend, 0.5 to a friend of the friend, and 0.25 to a friend of the friend of the friend, for a member A, D is a friend, B is a friend of the friend, and G is a friend of the friend of the friend. The personal connection storage means 8 may be included in the member information storage means 5.

How the point management device 1 recognizes a member in a friendship is not limited in particular, the following is one of them. A member X asks a member Y to be a friend by sending a mail. Upon receiving a mail of acknowledgement from the member Y, it is decided that the members X and Y become “friends.” Transmission and reception of a mail between X and Y is performed with the intervention of the point management device 1. Since processing of the forming personal connection can be obtained by combining existing methods, detailed descriptions will be abbreviated.

The point granting means 9 grants a member who has taken a specified action a point value according to the action to record the point balance in the member information storage means 5 for each member. For example, it is assumed that a member has posted a dairy ten times and a comment on other's diary five times until now. In this case, when applying the values in FIG. 6, the point amounts to 1125 points (100 points times 10 plus 25 points times 5) in total. When no granted points have been used, 1125 points are stored in the member information storage means 5 as point balance. When the member starts a community, point granting means 9 adds 250 points to update the point balance of the member information storage means 5 to 1375 points.

Discount information display means 10 makes point balance and discount information of a member displayed on a shop opening Web page when accessing from the purchaser terminal 2b of the member intended to purchase a product to the shop opening Web page. The member intended to purchase the product decides whether to purchase the product or not referring to the display. As for the processing of the discount information display means 10, details will be given in the description of the procedure of product purchase.

The point balance update means 11 subtracts the point value used by purchasing a product from the point balance of the member information storage means 5. For example, a member whose point valance is 1125 points uses a discount of 30 points at the time of purchasing a product, the point balance is updated to be 1095 points.

Here, it is the point management device 1 that manages the point value of each member and the opened shop is not involved. This is one of characteristics of the invention. Since each shop does not have to prepare and manage database for managing points, any exhibitor can provide a point discount service to a customer. For example, it is not realistic that a member intended to sell only a few avocational hand-knit sweaters has database for managing points independently. When utilizing the system of the invention, the member can discount the price using a point when a friend purchases the sweater.

In addition, the processing part 4 of the point management device 1 includes a function for replying an inquiry (for example, an inquiry about the current point balance) from a member, a function for managing and operating the member of a lower community formed in a community, and the like. However, Embodiment 1 has no need to include a function for settling member-to-member trades. A primary function is to store accumulated points for each member to update point balance when points are used. No function is included for mediating between a seller and a purchaser, giving a guarantee at the time of settlement, or the like. They are left to the liberty of a concerned party of trade.

Next, descriptions will be given to the procedure for a member-to-member trade while referring to FIG. 8.

When an access from the purchaser terminal 2b occurs (S10), the point management device 1 recognizes which member has accessed by a method such as to make the member input a member ID and displays a list of an online shop (S11). That is a screen composed of a list of the link to the purchasing screen page of each shop as shown by FIG. 9. When clicking any link, a Web page of a store or a product like FIG. 11 to be mentioned later will be displayed, which means that the member visited the sales site of the shop.

Here, a “member A” is assumed to have visited the shop of a “member B” and the “member B” is assumed to set a discount rate like FIG. 10. Here, an HTML file depicting the Web page of the shop of the “member B” recites that when the degree of relation is 1, that is, the purchaser is the friend of the “member B”, 88% discount is available by using the points, when the degree of relation is 0.5, that is the purchaser is a friend of the friend, 50% discount is available by using the points, and so on.

The discount information display means 10 extracts point balance of the “member A” from the member information storage means 5 and the friend of the “member A” from the personal connection storage means 8. When the “member B” is located from the personal connection storage means 8, the discount information display means 10 judges that discount is available from the seller “member B” (Yes at S12) and extracts a price and a discount rate from the HTML file to display the screen shown by FIG. 11 (S13). As shown in FIG. 11, the price after discount and point balance after purchasing the product are also displayed to be offered for reference of decision-making whether to purchase the product or not.

Upon deciding purchasing the product, a purchasing applicant clicks a “purchasing” button on a purchasing screen. The point management device 1 detects generation of an event of button click (Yes at S14) to judge that purchase has decided, subtract a point value corresponding to the displayed discount information from point balance, store the point balance after subtraction in the member information storage means 5 (S15), and notify the seller terminal 2a of which member has purchased by what discount amount (S16).

When the purchase applicant does not meet conditions of discount (No at S12), a purchasing screen as shown in FIG. 12 is displayed (S17), and the processing is moved to step S14. Neither discount nor changes in point balance are present.

When the “purchase” button is not clicked, that is, at the time of no purchase (No at S14), the processing is terminated.

According to the above procedure, the point management device I manages a point and the seller terminal 2a is notified of the discount amount by using the point by the point management device I. That is, the seller does not have to have database for managing the point in person. That is a significant difference from the invention of PTL 1.

Here, the seller can appropriately decide discount information. In the Web page data, constants are set by conditions that are satisfied by the purchaser. A processing described by a page description language such as Pert and PHP and a client control language such as JavaScript™ extracts discount information corresponding to conditions of the purchaser. In order to extract the discount information, a member ID is received as a parameter when requesting the Web page, and a member-to-member relationship is extracted from the personal connection storage means 8 based on the member ID. Under such a structure, the point management device 1 does not need to store the discount information, and the seller only performs self-management.

According to Embodiment 1, a point available for purchasing a product in the community is accumulated based on the degree of contribution to the community. The more action for other members is taken, the more point is granted, allowing part of the expense for the product sold by a friend to be paid by the point. The member actively behaves in the community, sales of products in the community are actively pursued, and the community formed via the Internet is energized. In the actual society, many local communities are on the decline such that they are called a limited community and a shuttered shopping area. The object of the invention is to activate the community formed on the Internet to vitalize the entire society.

### Embodiment 2

In Embodiment 1, discount information depends on the member-to-member relationship. Embodiment 2 is different in that the discount information is set according to the attribute of the member in the system. Only differences from Embodiment 1 will be described in the following.

The point management device 1 stores the attribute in the community related to contribution to the community for each member. The attribute may be stored in the member information storage means 5 or means for storing the attribution may be provided separately, Each seller may set the discount information by the community attribute to store setting contents as shown in FIG. 13 in an HTML file that describes the Web page.

Procedures at the time of purchase are almost the same as those of Embodiment 1 shown in FIG. 8. However, it is different in that discount information display means 10 does not refer to the member-to-member relationship but to the attribute in the community at the time of calculating the discount rate.

In the example of FIG. 13, a purchase applicant can reduce a sales price by an accumulated point within a range of 30% when having posted a bldg to the community even if having no specified human relationship with a seller.

Further, with the example of FIG. 13, the more the number of people invited to the community increases, the larger the discount rate is made. It is because since without invitation by an existing participant it is not possible to participate in the community such as an SNS in many cases, it is considered that when many guests are invited, the number of the member of the community is increased, resulting in great contribution to its development.

With Embodiment 2, for those only having a relationship of being a member belonging to the same community to each other, it is possible to express gratitude by discounting the price if the person contributes to the community.

### Embodiment 3

In Embodiments 1 and 2, the discount information has been described in a Web page data file. However, Embodiment 3 is different in that a point management device 101 includes discount information storage means 13 as shown in FIG. 14.

The discount information, that is, a discount rate or a discount amount is stored by corresponding it with discount conditions by the seller and product. The member intended to open a shop in the community transmits information on the product to the point management device 101 (refer to step S1 of FIG. 2). The discount information is transmitted simultaneously and the processing part 4 may register the received information in the discount information storage means 13.

The point management device 101 may set a predetermined value in the discount information storage means 13 in advance and the discount information that the seller has transmitted may be stored by the point management device 101.

With Embodiment 3, Web page data can be easily prepared. It is because the seller does not have to code a processing portion in which discount rate is calculated for each purchase applicant.

### Embodiment 4

Although the discount information is not equal and depends on a human relationship with the seller or the like in any of the above Embodiments, in Embodiment 4, the discount information is equal independent of conditions of the member. The function block of the point management device 101 is the same as that of Embodiment 3 (refer to FIG. 14) and the equal discount information is stored in the discount information storage means 13.

For example, this embodiment may be conceivable such that all products are subjected to discount by 10% In concert with a memorial day of the community, the season of a midsummer gift and a year-end gift in the world. However, it goes without saying that having point balance worth the discount amount is assumed.

In addition, as for a relation with the product, although discount information may be equal independent of the product, different discount information can be set by focusing on product kinds such as food and clothing.

With Embodiment 4, having an appreciation sale in the entire community can be easily performed and buying motivation of the members can be raised,

### Embodiment 5

In Embodiment 1, no settlement function is provided with the point management device 1.

Embodiment 5 is different in having the settlement function. In the following, only difference from Embodiment 1 will be explained. As shown in FIG. 15, point management device 201 includes settlement means 14.

A purchaser pays price after discount at a convenience store or with a credit card. Taking an example of paying at the convenience store, paid amount is usually transferred in the block to an alternate account. It is because since a primary seller of the invention is a private shop and a private person who sells a handmade product as a second job, it is difficult for such a seller to conclude contract of payment with a credit card company individually. In Embodiment 5, the alternate account is the account of the community and when the point management device 201 captures that payment is made, the amount is transferred to the account of the seller. Settlement means 14 performs processing of paying the amount received from the purchaser to the seller. However, this is an example and various settlement procedures are conceivable. The skilled person could easily implement any procedure into the settlement means 14.

In Embodiment 5, desirably the use of point is reserved when purchasing is determined and subtraction of discount amount from point balance by the point balance update means 11 is finalized after funds are transferred to the account of the seller by the settlement means 14.

### Embodiment 6

In any of Embodiments 1 to 5, the point management device includes database that stores point balance. Although there are cases in which the point balance is stored in storage media such as a hard disk, in a dedicated database server connected to LAN and WAN, and the like, they are regarded to be the same in that data of point balance is contained in the point management device because the same management body manages it.

However, Embodiment 6 is different from the above Embodiments in that an external database management device 302 connected via the Internet N includes point balance external storage means 303 that stores the point balance as shown in FIG. 16.

The point management device 301 does not have member information storage means as shown in FIG. 17 and database management device 302 may integrally manage data related to members including point balance. Alternatively, the member information storage means provided by the point management device 301 may store data except point balance only.

When all the point granting means 9, discount information display means 10, and point balance update means 11 of the point management device 301 are required to read out and write into point balance of the member, a command for database operation is issued via the communication interface part 12, the internet N, and the communication interface part (not shown) of the external database management device 302 to access the point balance external storage means 303. This allows the point management device 301 not to implement the software that manages point balance. Resultantly, for example, a shopping site administrator of the Internet manages the point balance external storage means and provides the API (Application Program Interface) of the point management to an existing social network system (an administrator) to achieve a system.

Descriptions are given to the present invention based on Embodiments 1 to 6, though, these Embodiments are nothing but an example. A variety of variations for a data structure and a processing flow and the like to be stored in each storage means is conceivable. These variations are a scope of the invention as well.

Some of the variations will be shown below.

With Embodiment 1, friends of each member are stored in a storage part 3 while being corresponded with the degree of intimacy. For example, when X and 0.5 are corresponded and stored, the member can immediately recognize that the member X is a friend of a friend. However, when the number of the members becomes large, they cannot be accommodated in the hard disk and the like. Therefore, only friends may be stored for each member. In the case where it is stored in the storage part 3 that the friend of the member A is B and the friend of the member B is A and C, when a processing to search the storage part 3 is added as the function of the processing part 4, it can be extracted that the member A and C are in a friend-of-friend relationship only by referring to information of the member B. Storage capacity can be suppressed when data is stored in such a way. In short, any data structure will be allowable as long as the relation between members can be extracted.

In Embodiment 2, an attribute is granted according to the degree of contribution to the community to be reflected to the discount amount. How to make the attribute correspond to discount information is an arbitrary matter of arrangement. A flexible operation may be expected such that discount rate is made to be different between posting to a parent community and posting to a lower community for a blog poster and a certain amount is tacked onto the maximum discount rate when a plurality of attributes is provided.

In Embodiment 6, descriptions are given assuming that the number of the point management device 301 is one referring to FIG. 16. However, as shown in FIG. 18, it is possible for two or more point management devices 301 to have database management service provided by one external database management device 302.

In this case, although the data structure of the database managed by the database management device 302 is common, each point management device 301 is assumed to be allowed to access data regarding one's own member stored in the point balance external storage means 303 only.

In any Embodiment above, a discount rate is used for discount information, though discount amount may be used. A case in which the discount rate is set according to a product or a seller and a case in which discount amount is set according to a product or a seller may be mixed.

In any Embodiment above, a nature of a community to be a parent is not limited in particular, but any configuration is allowable as long as a plurality of people may be gathered on the Internet. In recent years, SNS seems to be thriving, though the point management device 1 is operated by an administrator of the SNS and the member of the SNS may automatically be the member of the system of the present invention.

In any Embodiment above, a granted point value is assumed be used only for trading a product between the members. However, when synchronization of the database that stores point balance is guaranteed, the granted point can be used in other parent community and a product exhibiting site, or the like. As one of features of the present invention, integral management of point database by a system can be cited. As long as this feature is not deteriorated, there may be room to use the present invention in other community operated by a different operating body and a product exhibition site.

### INDUSTRIAL APPLICABILITY

By taking in spirit of service and expression of gratitude into a conventional point system and making those having performed activities for the community rewarded with money, various activities including an economic aspect of the community via the Internet can be vitalized.

### REFERENCE NUMERALS

1 point management device
2 (2a, 2b) member terminal
2a purchaser terminal
2b seller terminal
5 member information storage means
6 shop opening information storage means
7 point value storage means by action
8 personal connection storage means
9 point granting means
10 discount information display means
11 point balance update means
13 discount information storage means
14 settlement means
101 point management device
201 point management device
301 point management device
302 database management device
303 point balance external storage means
N the Internet

1. A device for managing member-to-member distribution point that is communicably connected with a group of member terminals, the group of member terminals being composed of terminals of community members to manage a point circulating among community members, comprising:
shop opening information storage means for storing information containing shop opening Web page data related to a member who opens a shop;
point value storage means classified by action for making each predetermined action (hereinafter referred to as a “specified action”) correspond with a point value;
point granting means for granting a point value to a member who has taken the specified action to record a point balance into member information storage means for each member;
discount information display means for making the shop opening Web page to display a point balance and discount information of the member when the member terminal of the member intended to purchase a product accesses the shop opening Web page; and
point balance update means for subtracting a point value used for purchasing a product from the point balance, wherein
the discount information is stored in the discount information storage means of the device for managing member-to-member distribution point, received from the member terminal of the member who has opened the shop to be registered into the discount information storage means, or described in the shop opening Web page data.

2. The device for managing member-to-member distribution point according to claim 1, wherein the device for managing member-to-member distribution point is operated by an administrator of an. SNS, and
a member of the SNS is a member constituting the present system.

3. The device for managing member-to-member distribution point according to claim 1 or 2, wherein
the specified action includes posting of a blog, posting of a comment to a blog, posting of a diary, posting of a comment to the diary of other members, posting of a product review, reply to the consultation from other members, start-up of a lower community, and invitation of a new participant to the community.

4. The device for managing member-to-member distribution point according to any of claims 1 to 3, further comprising:
means for storing a member-to-member relationship, wherein
the discount information includes a value set by member-to-member relationship, and
the discount information display means extracts and displays discount information corresponding to a relationship between a member who is an exhibitor and a member who is a purchaser.

5. The device for managing member-to-member distribution point according to any of claims 1 to 3, further comprising:
means for storing attribution in the community related to contribution to the community for each member, wherein
the discount information includes a value set by attribution in the community, and
the discount information display means extracts and displays the discount information corresponding to the attribution in the community of a member who is a purchaser.

6. The device for managing member-to-member distribution point according to claim 5, wherein
classifying of the member by the attribution in the community includes a blog poster, a diary poster, a consultation responder having expert knowledge, and those who invited others to the community.

7. The device for managing member-to-member distribution point according to any of claims 1 to 6 further comprising:
settlement means for settling the price that the member who has purchased a product pays to the member who is a seller after discount using the point,

8. The device for managing member-to-member distribution point according to any of claims 1 to 7, wherein
the device for managing member-to-member distribution point is connected to an external database management device via a communication line,
at least point balance among data stored in the member information storage means is stored in the point balance external storage means provided in the database management device, and the device for managing member-to-member distribution point reads and writes data from and to the point balance external storage means via a communication line.

9. A member-to-member distribution point system, wherein
a communicable connection of the device for managing member-to-member distribution point according to any of claims 1 to 7 with a member terminal group composed of a terminal of a community member accumulates a point usable among community members, and
the accumulated point is used for discount of a product among members.

10. A member-to-member distribution point system, wherein
a communicable connection among the device for managing member-to-member distribution point according to claim 8, a member terminal group composed of a terminal of a community member, and an external database management device accumulates a point usable among the community members, and
the accumulated point is used for discount of a product among members.

11. A method of distributing a point among members that accumulates a point in a community achieved by a device for managing member-to-member distribution point communicable with a member terminal group composed of terminals of community members and uses an accumulated point for discount of a product among the members, the method comprising:
a step of granting a point value to a member who has taken a predetermined action (hereinafter referred to as “specified action”) to the device for managing member-to-member distribution point, and recording the point balance in member information storage means by member, the device for managing member-to-member distribution point including:
shop opening information storage means for storing information containing shop opening Web page data related to a member who opens a shop; and
point value storage means by action for making each specified action correspond to a point value;
a step of making the shop opening Web page display point balance and discount information of the member when accessing from a member terminal of a member intended to purchase a product to the shop opening Web page; and
a step of subtracting a point value used for purchasing the product from the point balance, wherein
the method executes processing to display the discount information based on any of:
the discount information stored in discount information storage means of the device for managing member-to-member distribution point;
the discount information received from a member terminal of a member who opens a shop and registered in the discount information storage means, and
the discount information described in the shop opening Web page data.

12. A method of distributing a point among members that accumulates a point in a community achieved by a member terminal group composed of terminals of community members and a device for managing member-to-member distribution point communicable with an external database management device and uses the accumulated point for discount of a product among members, the method comprising:
a step of granting a point value to a member who has taken a predetermined action (hereinafter referred to as “specified action”) to the device for managing member-to-member distribution point, and recording the point balance in point balance external storage means for each member, the device for managing member-to-member distribution point including:
shop opening information storage means for storing information containing shop opening Web page data related to a member who opens a shop; and
point value storage means by action for making each specified action correspond to a point value, the device for managing member-to-member distribution point accessing point balance external storage means provided with the database management device to read or write data;
a step of making the shop opening Web page display point balance and discount information of the member when accessing from a member terminal of a member intended to purchase a product to the shop opening Web page; and
a step of subtracting a point value used for purchasing the product from the point balance, wherein
the method executes processing to display the discount information based on any of:
the discount information stored in discount information storage means of the device for managing member-to-member distribution point;
the discount information received from a member terminal of a member who opens a shop and registered in the discount information storage means; and
the discount information described in the shop opening Web page data.
